(19) United States
(12) Patent Application Publication
(10) Pub. No.: US 2003/0140749 A1
(43) Pub. Date: Jul. 31, 2003

(54) Brake Pawls for power equipment

(76) Inventors: Stephen F. Gass, Wilsonville, OR (US); David A. Fanning, Vancouver, WA (US)

Correspondence Address: SD3, LLC, 22409 S.W. NEWLAND ROAD, WILSONVILLE, OR, 97070, US

(21) Appl. No.: 10/341,260

(22) Filed: Jan. 13, 2003

Related U.S. Application Data
(60) Provisional application No. 60/351,797, filed on Jan. 25, 2002.

(51) Int. Cl. B23D 45/00

(52) U.S. Cl. 83/62.1; 83/DIG. 1

(57) ABSTRACT

Brake pawls for use in safety systems for power equipment are disclosed. The brake pawls include an energy-absorbing region. The energy absorbing regions may include a deformable or collapsible region made from apertures in the brake pawl or from collapsible members or from materials of differing hardnesses, strengths, or structures.

### CROSS-REFERENCE TO RELATED APPLICATION

This application claims the benefit of and priority from U.S. Provisional Patent Application Serial No. 60/351,797, filed Jan. 25, 2002, the disclosure of which is hereby incorporated by reference.

### FIELD

The present invention relates to safety systems for power equipment such as woodworking machines, and more particularly to brake pawls used to stop cutting tools in power equipment.

### BACKGROUND

Safety systems are often employed with power equipment such as table saws, miter saws, band saws, jointers, shapers, circular saws and other woodworking machinery, to minimize the risk of injury when using the equipment. Probably the most common safety feature is a guard that physically blocks an operator from making contact with dangerous components of machinery, such as belts, shafts or blades. In many cases, guards effectively reduce the risk of injury, however, there are many instances where the nature of the operations to be performed precludes using a guard that completely blocks access to hazardous machine parts.

Some safety systems detect when a person contacts a dangerous part of a machine, and then react to minimize the potential of serious injury. For example, some systems detect when a person contacts the blade of a power saw, and then react to stop the blade from spinning to minimize injury. In such systems, a brake pawl moves into the teeth of the blade to stop the blade.

Various brake pawls are disclosed herein for use in safety systems that include a brake mechanism adapted to engage a blade or other cutting tool to protect the user against serious injury if a dangerous, or triggering, condition occurs, such as contact between the user's body and the blade or other cutting element.

### BRIEF DESCRIPTION OF THE DRAWINGS

FIG. 1 is a schematic block diagram of a machine with a fast-acting safety system.

FIG. 2 is a schematic diagram of an exemplary safety system in the context of a machine having a circular blade.

FIG. 3 shows a brake pawl with a deformable or collapsible region.

FIG. 4 shows the brake pawl of FIG. 3 with the deformable or collapsible region collapsed.

FIG. 5 shows a brake pawl with a deformable or collapsible region made of an elongate aperture.

FIG. 6 shows the brake pawl of FIG. 5 with the deformable or collapsible region collapsed.

FIG. 7 shows a brake pawl with a deformable or collapsible region positioned at an angle relative to the elongate axis of the brake pawl.

FIG. 8 shows a brake pawl with a deformable or collapsible region including a collapsible member.

FIG. 9 shows a brake pawl with a deformable or collapsible region including a plurality of collapsible members.

FIG. 10 shows a brake pawl with a “T” shaped end having members that may bend or deform.

### DETAILED DESCRIPTION

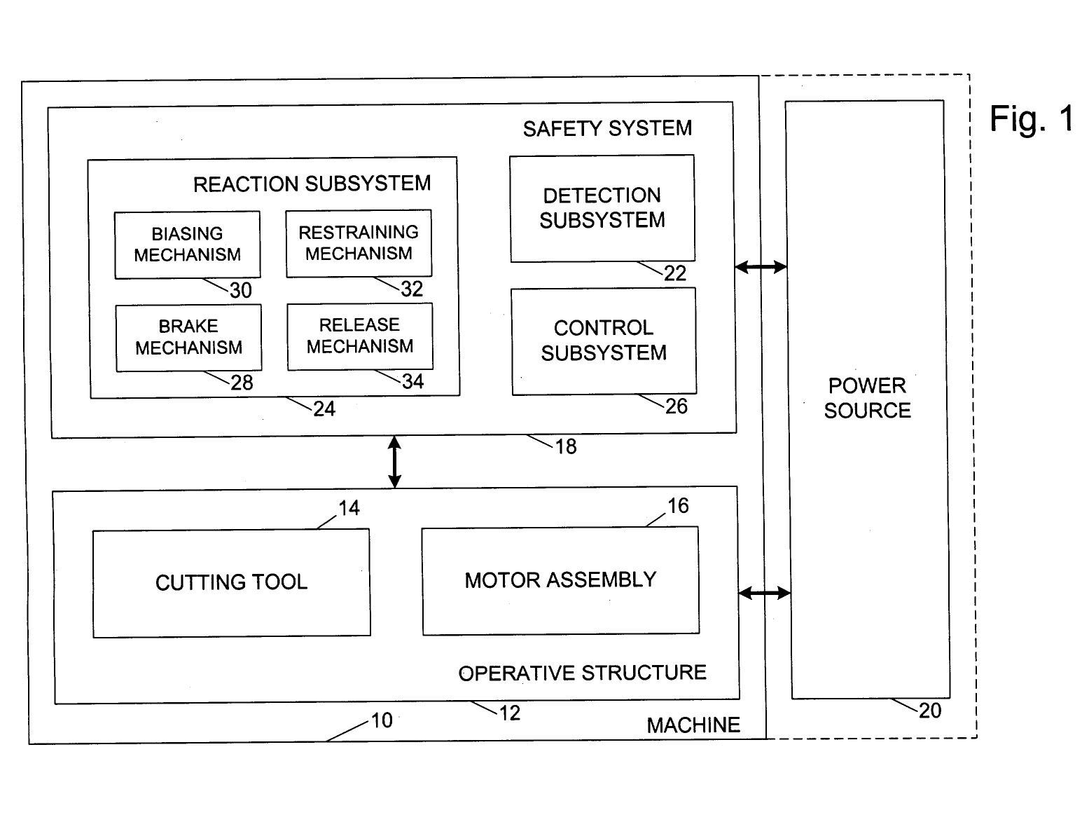

A machine with a fast-acting safety system is shown schematically at 10 in FIG. 1. Machine 10 may be any of a variety of different machines adapted for cutting workpieces, such as wood, including a table saw, miter saw (chop saw), radial arm saw, circular saw, band saw, jointer, planer, etc. Machine 10 includes an operative structure 12 having a cutting tool 14 and a motor assembly 16 adapted to drive the cutting tool. Machine 10 also includes a safety system 18 configured to minimize the potential of a serious injury to a person using machine 10. Safety system 18 is adapted to detect the occurrence of one or more dangerous, or triggering, conditions during use of machine 10. If such a dangerous condition is detected, safety system 18 is adapted to engage operative structure 12 to limit any injury to the user caused by the dangerous condition.

Machine 10 also includes a suitable power source 20 to provide power to operative structure 12 and safety system 18. Power source 20 may be an external power source such as line current, or an internal power source such as a battery. Alternatively, power source 20 may include a combination of both external and internal power sources. Furthermore, power source 20 may include two or more separate power sources, each adapted to power different portions of machine 10.

Operative structure 12 may take any one of many different forms, depending on the type of machine 10. For example, operative structure 12 may include a stationary housing configured to support motor assembly 16 in driving engagement with cutting tool 14. Alternatively, operative structure 12 may include a movable structure configured to carry cutting tool 14 between multiple operating positions. As a further alternative, operative structure 12 may include one or more transport mechanisms adapted to convey a workpiece toward and/or away from cutting tool 14.

Motor assembly 16 includes one or more motors adapted to drive cutting tool 14. The motors may be either directly or indirectly coupled to the cutting tool, and may also be adapted to drive workpiece transport mechanisms. Cutting tool 14 typically includes one or more blades or other suitable cutting implements that are adapted to cut or remove portions from the workpieces. The particular form of cutting tool 14 will vary depending upon the various embodiments of machine 10. For example, in table saws, miter saws, circular saws and radial arm saws, cutting tool 14 will typically include one or more circular rotating blades having a plurality of teeth disposed along the perimetrical edge of the blade. For a jointer or planer, the cutting tool typically includes a plurality of radially spaced-apart blades. For a band saw, the cutting tool includes an elongate, circuitous tooth-edged band.

Safety system 18 includes a detection subsystem 22, a reaction subsystem 24 and a control subsystem 26. Control subsystem 26 may be adapted to receive inputs from a variety of sources including detection subsystem 22, reaction subsystem 24, operative structure 12 and motor assembly 16. The control subsystem may also include one or more sensors adapted to monitor selected parameters of machine 10. In addition, control subsystem 26 typically includes one or more instruments operable by a user to control the machine. The control subsystem is configured to control machine 10 in response to the inputs it receives.

Detection subsystem 22 is configured to detect one or more dangerous, or triggering, conditions during use of machine 10. For example, the detection subsystem may be configured to detect that a portion of the user's body is dangerously close to, or in contact with, a portion of cutting tool 14. As another example, the detection subsystem may be configured to detect the rapid movement of a workpiece due to kickback by the cutting tool, as is described in U.S. patent application Ser. No. 09/676,190, titled “Safety Systems for Power Equipment,” filed Sep. 29, 2000, the disclosure of which is herein incorporated by reference. In some embodiments, detection subsystem 22 may inform control subsystem 26 of the dangerous condition, which then activates reaction subsystem 24. In other embodiments, the detection subsystem may be adapted to activate the reaction subsystem directly.

Once activated in response to a dangerous condition, reaction subsystem 24 is configured to engage operative structure 12 quickly to prevent serious injury to the user. The particular action to be taken by reaction subsystem 24 will vary depending on the type of machine 10 and/or the dangerous condition that is detected. For example, reaction subsystem 24 may be configured to do one or more of the following: stop the movement of cutting tool 14, disconnect motor assembly 16 from power source 20, place a barrier between the cutting tool and the user, or retract the cutting tool from its operating position, etc. The reaction subsystem may be configured to take a combination of steps to protect the user from serious injury. Placement of a barrier between the cutting tool and teeth is described in more detail in U.S. patent application Ser. No. 09/929,226, entitled “Cutting Tool Safety System,” filed Aug. 13, 2001, the disclosure of which is herein incorporated by reference. Retraction of the cutting tool from its operating position is described in more detail in U.S. patent application Ser. No. 09/929,242, entitled “Retraction System For Use In Power Equipment,” filed Aug. 13, 2001, the disclosure of which is herein incorporated by reference.

The configuration of reaction subsystem 24 typically will vary depending on which action(s) are taken. In the exemplary embodiment depicted in FIG. 1, reaction subsystem 24 is configured to stop the movement of cutting tool 14 and includes a brake mechanism 28, a biasing mechanism 30, a restraining mechanism 32, and a release mechanism 34. Brake mechanism 28 is adapted to engage operative structure 12 under the urging of biasing mechanism 30. During normal operation of machine 10, restraining mechanism 32 holds the brake mechanism out of engagement with the operative structure. However, upon receipt of an activation signal by reaction subsystem 24, the brake mechanism is released from the restraining mechanism by release mechanism 34, whereupon, the brake mechanism quickly engages at least a portion of the operative structure to bring the cutting tool to a stop.

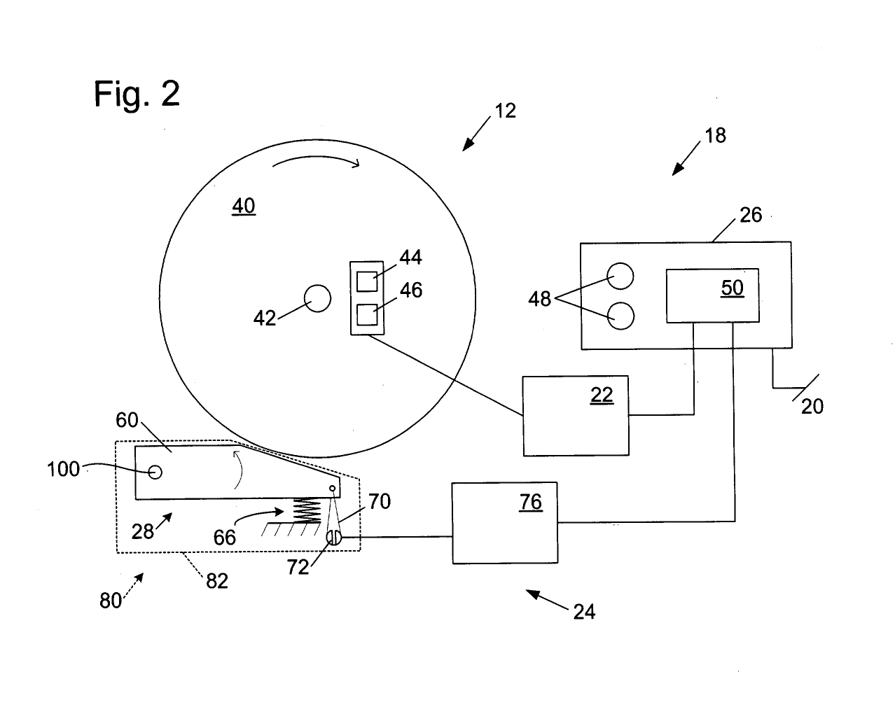

The exemplary embodiment depicted in FIG. 1 and described above may be implemented in a variety of ways depending on the type and configuration of operative structure 12. Turning attention to FIG. 2, one example of the many possible implementations of safety system 18 is shown. System 18 is configured to engage an operative structure having a cutting tool in the form of a circular blade 40 mounted on a rotating shaft or arbor 42. Blade 40 includes a plurality of cutting teeth (not shown) disposed around the outer edge of the blade. As described in more detail below, braking mechanism 28 is adapted to engage the teeth of blade 40 and stop the rotation of the blade. U.S. patent application Ser. No. 09/929,425, entitled “Translation Stop For Use In Power Equipment,” filed Aug. 13, 2001, the disclosure of which is herein incorporated by reference, describes other systems for stopping the movement of the cutting tool. U.S. patent application Ser. No. 09/929,235, entitled “Table Saw With Improved Safety System,” filed Aug. 13, 2001 and U.S. patent application Ser. No. 09/929,238, entitled “Miter Saw With Improved Safety System,” filed Aug. 13, 2001, the disclosures of which are herein incorporated by reference, describe safety system 18 in the context of particular types of machines 10.

In the exemplary implementation, detection subsystem 22 is adapted to detect the dangerous condition of the user coming into contact with blade 40. The detection subsystem includes a sensor assembly, such as contact detection plates 44 and 46, capacitively coupled to blade 40 to detect any contact between the user's body and the blade. Typically, the blade, or some larger portion of cutting tool 14 is electrically isolated from the remainder of machine 10. Alternatively, detection subsystem 22 may include a different sensor assembly configured to detect contact in other ways, such as optically, resistively, etc. In any event, the detection subsystem is adapted to transmit a signal to control subsystem 26 when contact between the user and the blade is detected. Various exemplary embodiments and implementations of detection subsystem 22 are described in more detail in U.S. patent application Ser. No. 09/929,426, entitled “Detection System For Power Equipment,” filed Aug. 13, 2001, U.S. patent application Ser. No. 09/929,221, entitled “Apparatus And Method For Detecting Dangerous Conditions In Power Equipment,” filed Aug. 13, 2001, U.S. Provisional Patent Application Serial No. 60/270,011, entitled “Contact Detection System for Power Equipment,” filed Feb. 20, 2001, U.S. Provisional Patent Application Serial No. 60/302,937, entitled “Discrete Proximity Detection System,” filed Jul. 2, 2001, and U.S. Provisional Patent Application Serial No. 60/335,970, entitled “Detection System for Power Equipment,” filed Nov. 13, 2001, the disclosures of which are herein incorporated by reference.

Control subsystem 26 includes one or more instruments 48 that are operable by a user to control the motion of blade 40. Instruments 48 may include start/stop switches, speed controls, direction controls, etc. Control subsystem 26 also includes a logic controller 50 connected to receive the user's inputs via instruments 48. Logic controller 50 is also connected to receive a contact detection signal from detection subsystem 22. Further, the logic controller may be configured to receive inputs from other sources (not shown) such as blade motion sensors, workpiece sensors, etc. In any event, the logic controller is configured to control operative structure 12 in response to the user's inputs through instruments 48. However, upon receipt of a contact detection signal from detection subsystem 22, the logic controller overrides the control inputs from the user and activates reaction subsystem 24 to stop the motion of the blade. Various exemplary embodiments and implementations of control subsystem 26 are described in more detail in U.S. patent application Ser. No. 09/929,237, entitled “Logic Control For Fast-Acting Safety System,” filed Aug. 13, 2001 and U.S. patent application Ser. No. 09/929,234, entitled “Motion Detecting System For Use In a Safety System For Power Equipment,” filed Aug. 13, 2001, the disclosures of which are herein incorporated by reference.

In the exemplary implementation, brake mechanism 28 includes a brake pawl 60 mounted adjacent the edge of blade 40 and selectively moveable to engage and grip the teeth of the blade. Pawl 60 may be constructed of any suitable material adapted to engage and stop the blade. As one example, the pawl may be constructed of a relatively high strength thermoplastic material such as polycarbonate, ultrahigh molecular weight polyethylene (UHMW) or Acrylonitrile Butadiene Styrene (ABS), etc., or a metal such as aluminum, etc. It will be appreciated that the construction of pawl 60 will vary depending on the configuration of blade 40. In any event, the pawl is urged into the blade by a biasing mechanism in the form of a spring 66. In the illustrative embodiment shown in FIG. 2, pawl 60 is mounted on a pivot pin 100, and is pivoted into the teeth of blade 40. It should be understood that sliding or rotary movement of pawl 60 may also be used. The spring is adapted to urge pawl 60 into the teeth of the blade with sufficient force to grip the blade and quickly bring it to a stop.

The pawl is held away from the edge of the blade by a restraining mechanism in the form of a fusible member 70. The fusible member is constructed of a suitable material adapted to restrain the pawl against the bias of spring 66, and also adapted to melt under a determined electrical current density. Examples of suitable materials for fusible member 70 include NiChrome wire, stainless steel wire, etc. The fusible member is connected between the pawl and a contact mount 72. Preferably, fusible member 70 holds the pawl relatively close to the edge of the blade to reduce the distance the pawl must travel to engage the blade. Positioning the pawl relatively close to the edge of the blade reduces the time required for the pawl to engage and stop the blade. Typically, the pawl is held approximately 1/32-inch to ¼-inch from the edge of the blade by fusible member 70, however other pawl-to-blade spacings may also be used within the scope of the invention.

Pawl 60 is released from its unactuated, or cocked, position to engage blade 40 by a release mechanism in the form of a firing subsystem 76. The firing subsystem is coupled to contact mount 72, and is configured to melt fusible member 70 by passing a surge of electrical current through the fusible member. Firing subsystem 76 is coupled to logic controller 50 and activated by a signal from the logic controller. When the logic controller receives a contact detection signal from detection subsystem 22, the logic controller sends an activation signal to firing subsystem 76, which melts fusible member 70, thereby releasing the pawl to stop the blade. Various exemplary embodiments and implementations of reaction subsystem 24 are described in more detail in U.S. patent application Ser. No. 09/929,240, entitled “Firing Subsystem For Use In a Fast Acting Safety System,” filed Aug. 13, 2001 and U.S. patent application Ser. No. 09/929,227, entitled “Spring-Biased Brake Mechanism for Power Equipment,” filed Aug. 13, 2001, the disclosures of which are herein incorporated by reference.

It will be appreciated that activation of the brake mechanism will require the replacement of one or more portions of safety system 18. For example, pawl 60 and fusible member 70 typically must be replaced before the safety system is ready to be used again. Thus, it may be desirable to construct one or more portions of safety system 18 in a cartridge that can be easily replaced. For example, in the exemplary implementation depicted in FIG. 2, safety system 18 includes a replaceable cartridge 80 having a housing 82. Pawl 60, spring 66, fusible member 70 and contact mount 72 are all mounted within housing 82. Alternatively, other portions of safety system 18 may be mounted within the housing. In any event, after the reaction system has been activated, the safety system can be reset by replacing cartridge 80. The portions of safety system 18 not mounted within the cartridge may be replaced separately or reused as appropriate. Various exemplary embodiments and implementations of a safety system using a replaceable cartridge are described in more detail in U.S. patent application Ser. No. 09/929,236, entitled “Replaceable Brake Mechanism For Power Equipment,” filed Aug. 13, 2001 and U.S. patent application Ser. No. 09/929,244, entitled “Brake Positioning System,” filed Aug. 13, 2001, the disclosures of which are herein incorporated by reference.

While one particular implementation of safety system 18 has been described, it will be appreciated that many variations and modifications are possible within the scope of the invention. Many such variations and modifications are described in U.S. patent application Ser. No. 09/676,190, the disclosure of which is herein incorporated by reference.

As mentioned above, safety system 18 may include a brake mechanism that is adapted to stop a cutting tool upon the detection of a dangerous condition, thereby preventing or reducing injury to the user. As also mentioned above, brake mechanism 28 may include at least one brake pawl adapted to engage and stop the motion of the cutting tool. A variety of brake pawls are disclosed in U.S. patent application Ser. No. 09/929,241, titled “Brake Mechanism for Power Equipment,” filed Aug. 13, 2001, which is incorporated herein by reference.

In brake mechanisms that include a brake pawl, a significant impact occurs when the brake pawl engages the cutting tool because of the speed at which the cutting tool typically moves. The resulting force of that impact may damage the machine in which the brake mechanism is installed, and/or the impact may damage the cutting tool. For example, in a table saw or miter saw having a spinning blade mounted on an arbor (like shaft 42 in FIG. 2), the force of the impact between the blade and the brake pawl may bend the arbor, thereby damaging the saw. The likelihood of damaging a machine or cutting tool from the force of the impact may be reduced by using a brake pawl that includes a collapsible or deformable region configured to absorb some of the energy and/or force of the impact.

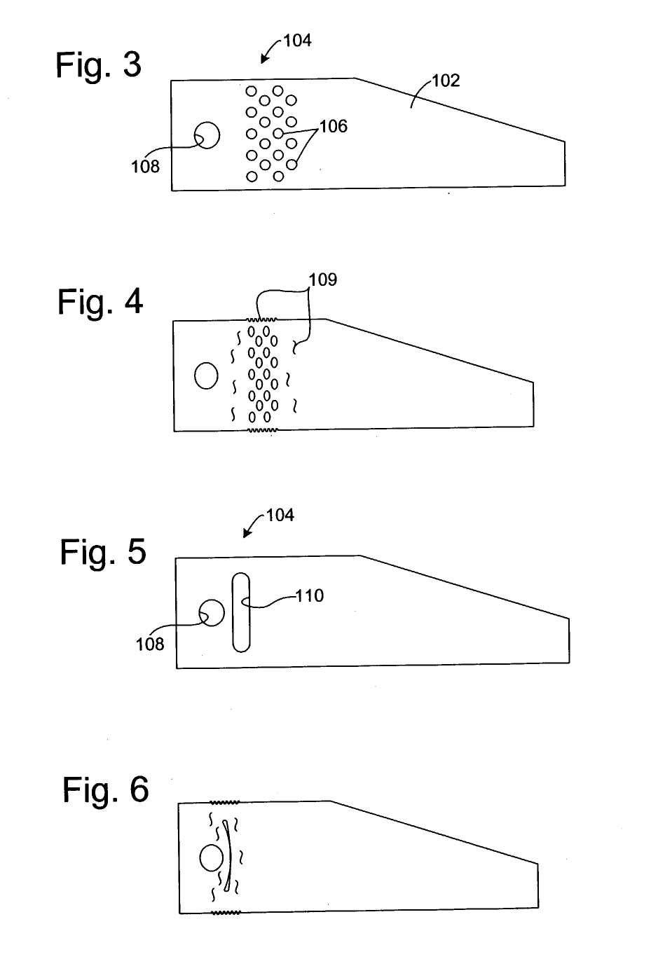

FIG. 3 shows a brake pawl 102 having an energy absorbing region 104 designed to deform or collapse when the pawl impacts a cutting tool. The deformation of region 104 helps the pawl absorb the energy of the spinning cutting tool and the force from the impact with the cutting tool, thereby reducing the likelihood that the impact will damage other parts of the machine or the cutting tool. In FIG. 3, region 104 comprises a series of holes extending through the pawl, such as holes 106. Of course, the number, size and configuration of the holes may vary. The holes create what may be thought of as a structurally weaker region of the brake pawl. Pawl 102 is designed to be mounted on a pivot pin extending through pivot hole 108. When the pawl impacts a spinning blade, for example, the blade cuts into the pawl and pushes the pawl against the pivot pin extending through hole 108, causing region 104 to deform or collapse and thereby absorb at least a part of the energy of the spinning blade. Typically the deformation will be a compression of region 104, as shown in FIG. 4, but the pawl may also bend or deform around region 104. The compression of region 104 is shown in FIG. 4 by wrinkles in the pawl, such as wrinkles 109, and by holes 106 being closer together and elliptical.

FIG. 5 shows a brake pawl with another possible configuration for a deformable or collapsible region 104. In this configuration, region 104 comprises an elongate aperture 110. The aperture is positioned adjacent pivot hole 108, and aperture 110 collapses as shown in FIG. 6. The collapse of that aperture absorbs some of the energy of the spinning cutting tool when the pawl impacts the cutting tool, thereby reducing the likelihood of damaging a machine or cutting tool.

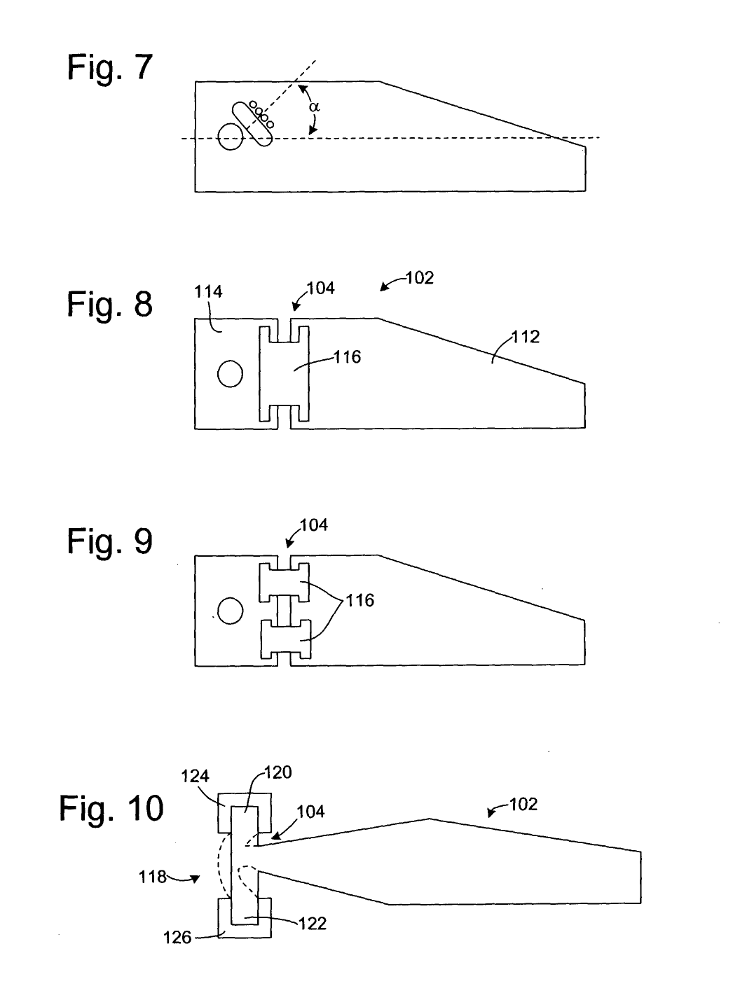

In some cases it may be desirable to position the deformable or collapsible region at an angle relative to the elongate axis of the pawl, as shown in FIG. 7. Positioning the deformable or collapsible region at an angle may be desirable in order to position the region between the point of impact of the cutting tool with the pawl and the pivot pin on which the pawl is mounted, so that the deformable or collapsible region is in line with the direction of force. Additionally, it is believed that the position of the deformable or collapsible region may affect how well the pawl grips the cutting tool when the cutting tool cuts impacts and cuts into the pawl.

FIG. 8 shows another possible configuration for a deformable or collapsible region 104. In FIG. 8, brake pawl 102 includes a first portion 112 and a second portion 114. A collapsible member 116 joins the first and second portions of the brake pawl. Collapsible member 116 may be made from a material that is different from the brake pawl. For example, the brake pawl may be made of aluminum, and the collapsible member may be made of a less hard aluminum or some other material such as urethane; or the brake pawl may be made of a hard plastic material and the collapsible member may be made of a softer, more compressible or deformable material. Collapsible member 116 may compress and/or bulge out between the first and second sections of the brake pawl when the pawl contacts a cutting tool.

FIG. 9 shows a brake pawl similar to the one shown in FIG. 8, except that the collapsible region 104 comprises two collapsible members 116 instead of one.

FIG. 10 shows another possible configuration for a deformable or collapsible region 104. In FIG. 10, brake pawl 102 includes a “T” shaped end 118 having members 120 and 122 mounted in brackets 124 and 126, respectively. The brackets, in turn, are mounted in a machine. When the pawl contacts a cutting tool, the force of the impact may deform the “T” shaped end 118 by bending members 120 and 122, as shown in dashed lines in FIG. 10.

Of course, there are many possible configurations for deformable or collapsible regions, and only a few are discussed above. Various apertures, collapsible members, materials, etc. may be used. The deformable or collapsible regions also may be thought of as energy-absorbing regions.

It also may be desirable to form brake pawls out of annealed aluminum to make the aluminum softer. Aluminum stops cutting tools quickly, and annealing the aluminum seems to lessen the likelihood that the aluminum will damage the cutting tool or machine upon impact with the cutting tool. For example, it is believed that an annealed aluminum brake pawl is less likely to knock teeth off a circular saw blade than an aluminum brake pawl which has not been annealed.

Several examples of other machines, processes and safety systems in which brake pawls may be employed may be found in the references incorporated above, as well as in the following references, the disclosures of which are herein incorporated by reference: PCT Patent Application Serial No. PCT/US00/26812, filed Sep. 29, 2000; U.S. patent application Serial No. 09/955,418, filed Sep. 17, 2001; U.S. Provisional Patent Application Serial No. 60/324,729, filed Sep. 24, 2001; U.S. Provisional Patent Application Serial No. 60/323,975, filed Sep. 21, 2001; U.S. Provisional Patent Application Serial No. 60/312,141, filed Aug. 13, 2001; U.S. Provisional patent application Serial No. 60/308,492, filed Jul. 27, 2001; U.S. Provisional Patent Application Serial No. 60/307,756, filed Jul. 25, 2001; U.S. Provisional Patent Application Serial No. 60/306,202, filed Jul. 18, 2001; U.S. Provisional Patent Application Serial No. 60/302,916, filed Jul. 3, 2001; U.S. Provisional Patent Application Serial No. 60/298,207, filed Jun. 13, 2001; U.S. Provisional Patent Application Serial No. 60/292,100, filed May 17, 2001; U.S. Provisional Patent Application Serial No. 60/279,313, filed Mar. 27, 2001; U.S. Provisional Patent Application Serial No. 60/275,595, filed Mar. 13, 2001; U.S. Provisional Patent Application Serial No. 60/275,594, filed Mar. 13, 2001; U.S. Provisional Patent Application Serial No. 60/273,902, filed Mar. 6, 2001; U.S. Provisional Patent Application Serial No. 60/273,178, filed Mar. 2, 2001; U.S. Provisional Patent Application Serial No. 60/273,177, filed Mar. 2, 2001; U.S. Provisional Patent Application Serial No. 60/270,942, filed Feb. 22, 2001; U.S. Provisional Patent Application Serial No. 60/270,941, filed Feb. 22, 2001; and U.S. Pat. No. 4,267,914, issued May 19, 1981 to Saar.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and sub-combinations of the various elements, features, functions and/or properties disclosed herein. No single feature, function, element or property of the disclosed embodiments is essential to all of the disclosed inventions. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and sub-combinations that are directed to one of the disclosed inventions and are novel and non-obvious. Inventions embodied in other combinations and sub-combinations of features, functions, elements and/or properties may be claimed through amendment of the present claims or presentation of new claims in this or a related application. Such amended or new claims, whether they are directed to a different invention or directed to the same invention, whether different, broader, narrower or equal in scope to the original claims, are also regarded as included within the subject matter of the inventions of the present disclosure.

1. A brake pawl for use in a safety system for a power tool, where the power tool includes a moving cutting tool, the brake pawl comprising:
a first region adapted to engage the moving cutting tool; and
an energy-absorbing region adapted to absorb at least some of the energy of the moving cutting tool.

2. The brake pawl of claim 1, where the energy-absorbing region is a collapsible region.

3. The brake pawl of claim 1, where the energy-absorbing region is a deformable region.

4. The brake pawl of claim 1, where the energy-absorbing region comprises holes.

5. The brake pawl of claim 1, where the energy-absorbing region is structurally weaker than the first region.

6. The brake pawl of claim 1, where the brake pawl includes a mounting region adapted to mount the brake pawl on a pivot pin.

7. The brake pawl of claim 1, where the energy-absorbing region comprises an elongate aperture.

8. The brake pawl of claim 1, where the brake pawl includes a mounting region adapted to mount the brake pawl on a pivot pin, and where the energy-absorbing region comprises an aperture adjacent the mounting region.

9. The brake pawl of claim 1, where the brake pawl includes a mounting region adapted to mount the brake pawl in the power tool, and where the energy-absorbing region is between the first region and the mounting region.

10. The brake pawl of claim 1, where the energy-absorbing region is shaped to deform.

11. The brake pawl of claim 10, where the energy absorbing region is shaped like a “T” with two ends, and where the where the two ends are adapted to mount in brackets.

12. The brake pawl of claim 1, where the energy-absorbing region is annealed aluminum.

13. The brake pawl of claim 1, where the first region is annealed aluminum.

14. The brake pawl of claim 1, where both the first region and the energy-absorbing region are annealed aluminum.

15. A brake pawl for use in a safety system for a power tool, where the power tool includes a moving cutting tool, the brake pawl comprising:
a first portion adapted to engage the moving cutting tool;
a second portion adapted to mount in the power tool; and
an energy-absorbing portion positioned between the first and second portions.

16. The brake pawl of claim 15, where the energy-absorbing portion is deformable.

17. The brake pawl of claim 15, where the energy-absorbing portion is collapsible.

18. The brake pawl of claim 15, where the energy-absorbing portion is a collapsible member joining the first and second portions, and where the collapsible member is made of a material that is different from the first portion.

19. The brake pawl of claim 15, where the energy-absorbing portion comprises a plurality of collapsible members joining the first and second portions.

20. A brake pawl for use in a safety system for a power tool, where the power tool includes a moving cutting tool, the brake pawl comprising:
a first region adapted to engage the moving cutting tool; and
means for collapsing or deforming to absorb at least some of the energy of the moving cutting tool.
